(19) United States
(12) Patent Application Publication
(10) Pub. No.: US 2018/0046428 A1
(43) Pub. Date: Feb. 15, 2018

(54) PRESERVING AN EXTERNAL DISPLAY CONFIGURATION

(71) Applicant: International Business Machines Corporation, Armonk, NY (US)

(72) Inventors: Ilse M. Breedvelt-Schouten, Manotick (CA); Jana H. Jenkins, Raleigh, NC (US); Jeffrey A. Kusnitz, Campbell, CA (US); John A. Lyons, Ottawa (CA)

(21) Appl. No.: 15/798,522

(22) Filed: Oct. 31, 2017

Related U.S. Application Data
(63) Continuation of application No. 15/234,049, filed on Aug. 11, 2016.

(51) Int. Cl. G06F 3/14; G06F 3/0486; G06F 3/0481

(52) U.S. Cl. CPC G06F 3/1454; G06F 2203/04803; G06F 3/0481; G06F 3/0486

(57) ABSTRACT

Embodiments are an approach to maintaining a shared application window environment based on minoring the shared application windows of a secondary display to a buffer by a display proxy. When a disconnection of the secondary display is detected the display proxy creates a framed window and transfers the applications previously displayed on the secondary display to the framed window. The relative sizes and positions of the application windows are maintained and the window sharing users are unaware of the transfer from the secondary display to the framed window. If desired, the application windows can be transferred to a different secondary display.

### BACKGROUND OF THE INVENTION

The present invention relates generally to management of a display and more specifically, to preserving an external display when disconnecting an external display device.

The use of laptop computers has become commonplace but a drawback with laptop computers is the small screen size. For desktop uses, a user typically overcomes this deficiency with one or more external monitors. In another aspect related to meetings and/or presentations a user connects a laptop to a projector or an external monitor. In both cases disconnecting the external device can lead to application display confusion.

For example, consider attending a meeting wherein the presenter has a laptop computer connected to a projector and the group is required to move to another location based on a conference scheduling issue. When the user disconnects the laptop from the external display, i.e. the external monitor or projector, the laptop transfers the application windows presently displayed on the external display to the laptop display and mingles the application windows with windows from other applications running on the laptop. Accordingly, when the user connects the laptop to another external display in a secondary meeting location, the user must again arrange application windows to restore the desired separations between the applications running on the laptop.

In another example, when a user connects a laptop to one or more external monitors at a work location, the user configures application windows to personal taste based on the connected external displays. When the user changes locations to a customer site or home without external displays, the laptop forces the application windows to the laptop display and the external display configuration is lost. When the user returns to the work location the user must reconfigure the application windows to the appropriate location on the appropriate display, either laptop display or external display. Application window location and size configurations are lost each time the associated external display connection is lost.

### SUMMARY

According to an embodiment of the present invention, a method for maintaining the contents of a shared secondary display when the secondary display is connected or disconnected from a display system, the method comprising: mirroring, by an external display component, one or more application windows associated with a secondary display to a buffer, wherein the mirroring comprises intercepting updates directed from the display system toward the secondary display and writing the updates to the buffer; detecting, by an external display component, a disconnection of the secondary display from a display system or a connection of the secondary display to the display system, wherein the detecting is based on at least one of receiving, by an external display component, a message indicating the connection, a message indicating the disconnection or polling one or more display ports associated with the secondary display; creating, by the external display component, a framed window, associated with the secondary display, on the display system and adding an application window to the framed window or removing an application window from the framed window based on user interaction; transferring, by the external display component, the one or more application windows previously displayed on the secondary display to the framed window while the one or more application windows maintain their relative sizes and positions with respect to their size and position on the secondary display or the one or more application windows associated with a framed window to an external display associated with the display system wherein the external display component removes the framed window after the transfer; and updating, by the external display component, the one or more application windows based on the buffer, wherein users sharing the one or more application windows are unaware of the transferring.

### BRIEF DESCRIPTION OF THE DRAWINGS

FIG. 1 is a functional block diagram generally depicting an external display device environment, in accordance with an embodiment of the present invention;

FIG. 2 is a functional block diagram depicting an external display component, in accordance with an embodiment of the present invention;

FIGS. 3A and 3B are an example of the relocation of shared application windows from an external device to a framed window, in accordance with an embodiment of the present invention;

FIG. 4 is a flowchart depicting operational steps of a method for preserving a secondary display, within an external display device environment, in accordance with an embodiment of the present invention; and

FIG. 5 is a block diagram of components of a prototype generation computer and a user prototype execution computer of an application prototype generation computing environment, in accordance with an embodiment of the present invention.

### DETAILED DESCRIPTION

The embodiments depicted and described herein recognize the benefits of preserving the contents of a secondary display/projector with respect to the contents of a primary display when the secondary display/projector is disconnected. In one example, the user can continue to share the contents of the disconnected secondary display or projector in a framed window appearing on the primary display when the secondary display/projector is disconnected. In another example the user can persist the contents of the framed window for reconnection to a secondary display/projector without requiring reconfiguration of the applications and their associated window size and/or positions when reconnecting to a secondary display/projector.

In describing embodiments in detail with reference to the figures, it should be noted that references in the specification to “an embodiment,” “other embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, describing a particular feature, structure or characteristic in connection with an embodiment, one skilled in the art has the knowledge to affect such feature, structure or characteristic in connection with other embodiments whether or not explicitly described.

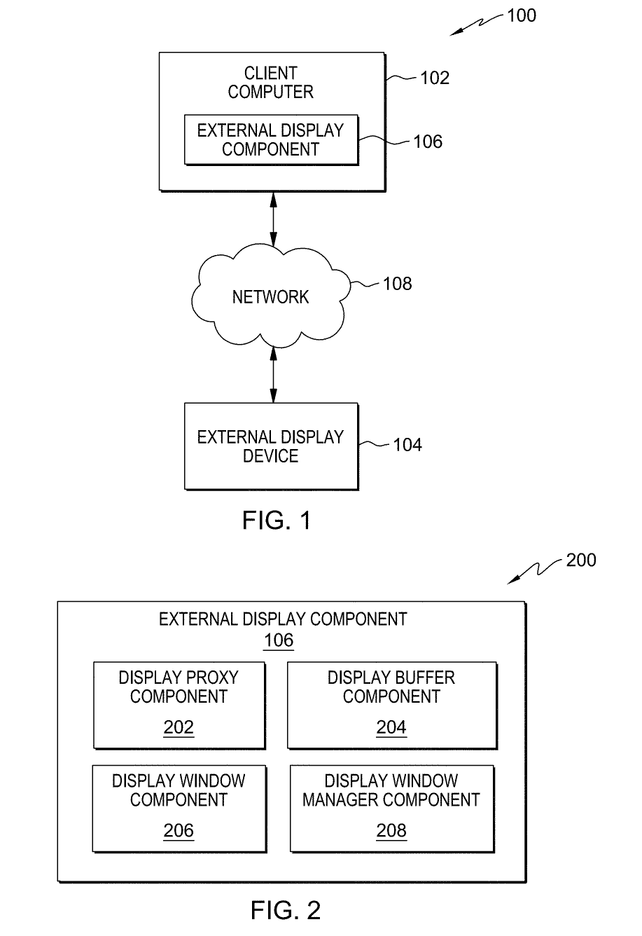

FIG. 1 is a functional block diagram illustrating, generally, an embodiment of a secondary display persistence environment 100. The secondary display persistence environment 100 comprises an external display component 106 operating on a client computer 102, an external display devices 104 and a network 108 supporting communications between the client computer 102 and the external display device 104.

Client computer 102 can be a standalone computing device, management server, a web server, a mobile computing device, or any other electronic device or computing system capable of receiving, sending, and processing data. In other embodiments, client computer 102 can represent a server computing system utilizing multiple computers as a server system. In another embodiment, client computer 102 can be a laptop computer, a tablet computer, a netbook computer, a personal computer, a desktop computer or any programmable electronic device capable of communicating with other computing devices (not shown) within secondary display persistence environment 100 via network 108. It should be noted that the client computer is also known as a display system for the purpose of describing the embodiments of the present invention.

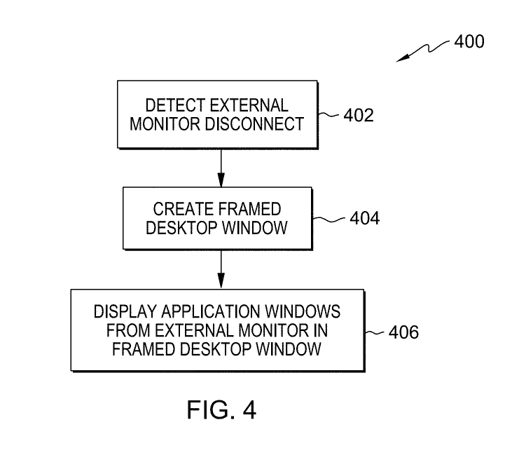

In another embodiment, client computer 102 represents a computing system utilizing clustered computers and components (e.g., database server computers, application server computers, etc.) that act as a single pool of seamless resources when accessed within secondary display persistence environment 100. Client computer 102 can include internal and external hardware components, as depicted and described in further detail with respect to FIG. 4.

External display component 106 can be a framework for preserving the contents of a secondary display based on detecting the disconnection of the secondary display. The detection of a disconnection results in identifying applications currently outputting display to the secondary display and transferring this displayed output to a framed window displayed on the primary display rather than allowing this display to intermix with the display of application windows displayed on the primary display.

Network 108 can be, for example, a local area network (LAN), a wide area network (WAN) such as the Internet, a combination of the two or a direct connection, and can include wired, wireless, or fiber optic connections. In general, network 108 can be any combination of connections and protocols that will support communications between client computer 102 and external display device 104.

External display device 104 can be a standalone computing device, management server, a web server, a mobile computing device, or any other electronic device or computing system capable of receiving, sending, processing and projecting data for display. In other embodiments, external display device 104 can represent a server computing system utilizing multiple computers as a server system. In another embodiment, external display device 104 can be a laptop computer, a tablet computer, a netbook computer, a personal computer, a desktop computer, or any programmable electronic device capable of communicating with other computing devices (not shown) within secondary display persistence environment 100 via network 108. It should be noted that external display device 104 is also known as a secondary display for the purpose of describing the embodiments of the present invention.

In another embodiment, external display device 104 represents a computing system utilizing clustered computers and components (e.g., database server computers, application server computers, etc.) that act as a single pool of seamless resources when accessed within secondary display persistence environment 100. External display device 104 can include internal and external hardware components, as depicted and described in further detail with respect to FIG. 4.

FIG. 2 is a functional block diagram 200 depicting external display component 106 comprising display proxy component 202, display buffer component 204, display window component 206 and application window manager component 208.

Display proxy component 202 of an embodiment of the present invention provides the capability to maintain a proxy for each external display. For example, during operation the display proxy component 202 maintains a display buffer, managed by display buffer component 204, of the display on the associated external display and any changes made to the external display, i.e., the proxy makes the changes to the display buffer and mirrors the changes from the display buffer to the external display. In one example of an embodiment, the display proxy component operates as a filter driver for a display driver associated with the display adapter, i.e., intercepts the writes to the display adapter by applications and applies the writes to the managed display buffer and to the associated external display.

In other aspects of the display proxy component 202, it should be noted that display proxy component 202 can manage multiple buffers for multiple external displays at the same time. Further, display proxy component 202, can detect when the external display is disconnected. The display proxy component 202 can base the aforementioned detection on techniques such as, but not limited to, receiving a notification message that the external display is disconnected and polling hardware locations, e.g., ports, to determine that the external display is no longer connected.

In another aspect of the display proxy component 202, display proxy component 202 provides the capability for a user to direct the shared application windows associated with a framed window to transfer to an external display associated with the display system. In this manner the user can transfer the shared application windows, for example, from an external monitor to a projector.

Display buffer component 204 of an embodiment of the present invention provides the capability to create one or more buffers for an external display device and provides the one or more buffers to display proxy component 202 for use with an associated external display component. The display buffer component also provides the capability to manage the scope of the buffer for changes such as, but not limited to, external display size, external display resolution, etc. It should be noted in the embodiments that the display buffer component can reconfigure a buffer after initial configuration if the requirements of the external display change based on, for example, connecting to a different external display or reconfiguring the display adapter to a different resolution.

Display window component 206 provides the capability to create a framed window on the default display for a buffer managed by display proxy component 202 and map the display currently in the buffer to the framed window. Display window component 206 creates the framed window when, for example, the external display is disconnected. It should be noted in the embodiments that there can be a framed window for each of one or more external displays. It should further be noted in the embodiments that the framed window is updated while the external display is disconnected and continues to provide the collection of application windows configured by the user for presentation on the specified external display. Further, the user can continue to add or delete application windows from the framed window just as if the external display was still connected. For the case of screen sharing applications, the screen sharing participant will not be aware that the user has disconnected the external display, i.e. uninterrupted bumpless screen sharing. It should be noted that a default display is, for a laptop example, the display associated with the laptop when no external displays are connected to the laptop.

Application window manager component 208 provides the capability to move application windows from the default display or other external monitors to the framed window for display to the screen sharing participant or to move application windows from the framed window to the default display or to another external monitor. The screen sharing participant is unaware whether the windows they are sharing are on an external display or in a framed window on a default display. Significantly, if an external display is disconnected, the application windows are displayed within the framed window rather than reverting to the default display and mingling with other windows displayed on the default display. It should further be noted that if there are multiple framed windows, application windows can be moved, e.g., by a drag-and-drop mechanism, from one framed window to another framed window.

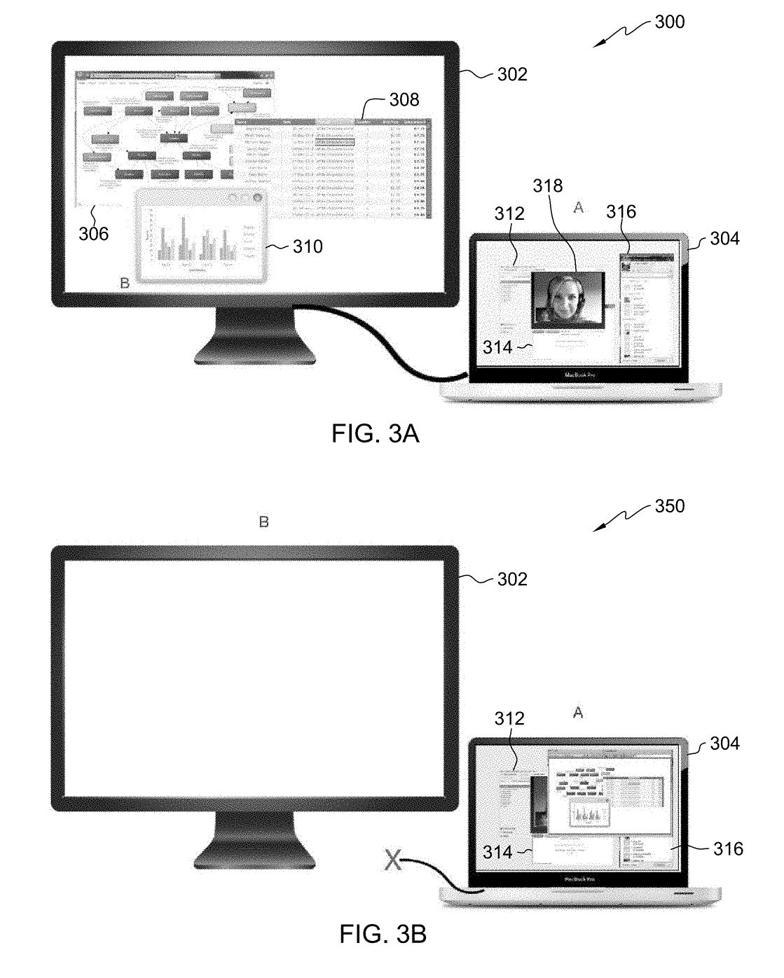

Turning to FIG.s 3A and 3B, consider, for example, FIG. 3A depicting screen sharing environment 300 wherein a user connects their laptop 304 to an external display 302 and configures three application windows 306, 308, 310 for screen sharing. It should be noted that three additional application windows 312, 314, 316 remain on the default display and are not visible with respect to the screen sharing application 318. Next, at FIG. 3B, the external display 302, of screen sharing environment 350, is disconnected from the laptop 304. The display window component 206 creates a framed window 352 and the three application windows 306, 308, 310 previously displayed on the external display 302 are displayed, based on relocation by the application window manager component 208, within the framed window 352. The screen sharing continues in an uninterrupted and bumpless manner because the display proxy component 202 manages the application windows in the buffer provided by the display buffer component 204.

While continuing the screen sharing in the framed window, the user can add/remove application windows to/from the framed window. It should be noted that should the user connect the laptop to another external display 302, the contents of the framed window 308 can be transferred to the external display 302 either automatically, if configured, or by manual selection. As described previously, the screen sharing participants are unaware of the transfer of application windows 306, 308, 310 between external displays 302 and framed windows 308. It should further be noted that if there are multiple framed windows, application windows can be moved, e.g., by a drag-and-drop mechanism, from one framed window to another framed window.

FIG. 4 is a flowchart of a method 400 depicting operational steps to preserve the contents of a secondary display when unplugging the external monitor or projector. Looking to FIG. 4, step 402, display proxy component 202 detects a disconnection of a connected display device. For example, display proxy component 202 detects a disconnection of hardware such as, but not limited to, an external display, a screen projector, etc. from a computer.

Next, at step 404, display window component 206 creates a framed window for association with the buffer, provided by display buffer component 204 and managed by display proxy component 202, for the disconnected display device. For example, a user is in a meeting in a conference room sharing application windows displayed on an external monitor. The user is instructed to move to another conference room and must disconnect the laptop computer from the external device. The user disconnects the laptop from the external device and a framed window appears on the laptop default display.

Continuing at step 406, the application window manager component 208 maps the application windows that were displayed on the external device to the framed window. It should be noted that relative size and position of the application windows on the external device are maintained on the framed window. At this point, the user can continue sharing the windows through the framed window or can connect the laptop to another external display or projector, all without the participants of the meeting knowing the shared application windows have moved.

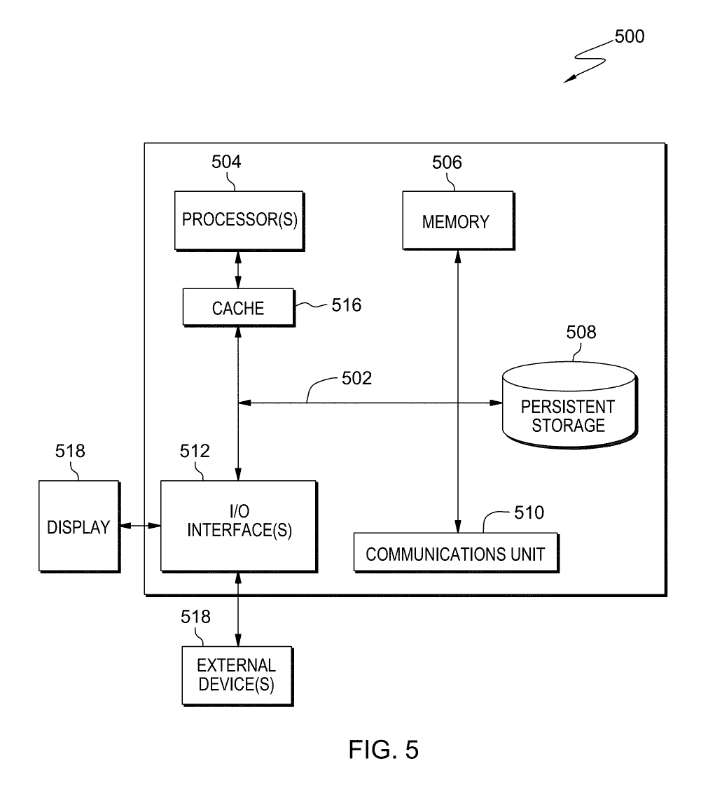

FIG. 5 depicts computer system 500, an example computer system representative of disruption indicator generation computer 102 and communication feeds computer 104. Computer system 500 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Computer system 500 includes processors 504, cache 516, memory 506, persistent storage 508, communications unit 510, input/output (I/O) interface(s) 512 and communications fabric 502. Communications fabric 502 provides communications between cache 516, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses or a crossbar switch.

Memory 506 and persistent storage 508 are computer readable storage media. In this embodiment, memory 506 includes random access memory (RAM). In general, memory 506 can include any suitable volatile or non-volatile computer readable storage media. Cache 516 is a fast memory that enhances the performance of processors 504 by holding recently accessed data, and data near recently accessed data, from memory 506.

Program instructions and data used to practice embodiments of the present invention may be stored in persistent storage 508 and in memory 506 for execution by one or more of the respective processors 504 via cache 516. In an embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices. In these examples, communications unit 510 includes one or more network interface cards. Communications unit 510 may provide communications through the use of either or both physical and wireless communications links. Program instructions and data used to practice embodiments of the present invention may be downloaded to persistent storage 508 through communications unit 510.

I/O interface(s) 512 allows for input and output of data with other devices that may be connected to each computer system. For example, I/O interface 512 may provide a connection to external devices 518 such as a keyboard, keypad, a touch screen, and/or some other suitable input device. External devices 518 can also include portable computer readable storage media such as, for example, thumb drives, portable optical or magnetic disks, and memory cards. Software and data used to practice embodiments of the present invention can be stored on such portable computer readable storage media and can be loaded onto persistent storage 508 via I/O interface(s) 512. I/O interface(s) 512 also connect to display 520.

Display 520 provides a mechanism to display data to a user and may be, for example, a computer monitor.

The components described herein are identified based upon the application for which they are implemented in a specific embodiment of the invention. However, it should be appreciated that any particular component nomenclature herein is used merely for convenience, and thus the invention should not be limited to use solely in any specific application identified and/or implied by such nomenclature.

The present invention may be a system, a method and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems) and computer program products according to embodiments of the invention. It is understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality and operation of possible implementations of systems, methods, and computer program products according to various embodiments of the present invention. In this regard, each block in the flowchart or block diagrams may represent a module, segment or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for maintaining the contents of a shared secondary display when the secondary display is connected or disconnected from a display system, the method comprising:
mirroring, by an external display component, one or more application windows associated with a secondary display to a buffer, wherein the mirroring comprises intercepting updates directed from the display system toward the secondary display and writing the updates to the buffer;
detecting, by an external display component, a disconnection of the secondary display from a display system or a connection of the secondary display to the display system, wherein the detecting is based on at least one of receiving, by an external display component, a message indicating the connection, a message indicating the disconnection or polling one or more display ports associated with the secondary display;
creating, by the external display component, a framed window, associated with the secondary display, on the display system and adding an application window to the framed window or removing an application window from the framed window based on user interaction;
transferring, by the external display component, the one or more application windows previously displayed on the secondary display to the framed window while the one or more application windows maintain their relative sizes and positions with respect to their size and position on the secondary display or the one or more application windows associated with a framed window to an external display associated with the display system wherein the external display component removes the framed window after the transfer; and
updating, by the external display component, the one or more application windows based on the buffer, wherein users sharing the one or more application windows are unaware of the transferring.
